(19) United States
(12) Patent Application Publication
(10) Pub. No.: US 2024/0271414 A1
(43) Pub. Date: Aug. 15, 2024

(54) APPARATUS AND METHODS FOR PANELS AND ACCESSORIES FOR USE IN WET ENVIRONMENTS SUCH AS BATHS AND SHOWERS

(71) Applicant: GRC Prime Bath LLC, Federal way, WA (US)

(72) Inventor: Michael Scott McGee, Federal way, WA (US)

(21) Appl. No.: 18/384,387

(22) Filed: Oct. 27, 2023

Related U.S. Application Data
(60) Provisional application No. 63/445,081, filed on Feb. 13, 2023.

(51) Int. Cl. E04B 1/64; B41M 7/00

(52) U.S. Cl. CPC E04B 1/648; B41M 7/0027

(57) ABSTRACT

The present invention introduces a bath or shower system panel and a distinctive method for its production. The panel is constructed from a porous substrate plate, primarily made from ABS (acrylonitrile butadiene styrene), onto which an image is directly printed using either 2-dimensional or 3-dimensional ink. To enhance durability and provide waterproofing, a UV-cured coating is directly applied onto the printed image. This coating can be silicone-compatible, allowing for effective sealing of multiple panels at their edges. The uniqueness of the system lies in the direct ink printing, which forgoes the use of intermediaries like binders, and in the UV-cured coating, which not only offers water resistance but also chemical resistance and potential antimicrobial properties. The invention also covers methods of panel production, emphasizing substrate plate formation, UV printing, and the separate UV-cured coating application processes. This system reimagines bath/shower paneling for enhanced visual appeal, durability, and functionality.

### CROSS-REFERENCE TO RELATED PATENT DOCUMENTS

This patent application claims the benefit of priority of U.S. Provisional Application No. 63/445,081, entitled “APPARATUS AND METHODS FOR PANELS AND ACCESSORIES FOR USE IN WET ENVIRONMENTS SUCH AS BATHS AND SHOWERS,” filed Feb. 13, 2023, which is hereby incorporated herein by reference in its entirety.

### FIELD OF THE INVENTION

The present invention relates to panels designed for walls, floors, and ceilings, as well as accessory structures derived from these panels, and their associated manufacturing methods. These panels and structures are particularly suited for moisture-prone environments found in residential, office, and commercial spaces, such as bathrooms, showers, bathtub enclosures, and kitchens. Specifically, the invention encompasses panels and accessories that are distinguished by their high quality, durability, scratch resistance, water resistance, chemical resistance, and aesthetic appeal, with some embodiments featuring a 3-dimensional texture. These panels and accessories are innovatively crafted from a reduced number of components and through more efficient manufacturing processes than traditional methods and compositions.

### BACKGROUND

In modern construction, it has become increasingly important to ensure the longevity and durability of materials used in areas exposed to moisture, such as bathrooms, kitchens, and certain commercial spaces. Traditional building materials, while functional, often fall short in terms of water resistance, aesthetic appeal, and resistance to scratches or chemicals.

The degradation of such materials in wet environments not only diminishes the aesthetic value of a space but can also introduce structural and health concerns due to mold, mildew, and material breakdown.

Furthermore, conventional panels and related structures commonly used in these settings are often constructed from numerous components, which can complicate the manufacturing process and increase production costs. There's also an environmental concern, as increased components and complex manufacturing processes tend to leave a larger carbon footprint.

There has been a longstanding demand in the construction and interior design industries for materials that not only exhibit enhanced water and scratch resistance but also offer an aesthetic appeal that is both stylish and enduring. Additionally, there has been a push towards streamlining the manufacturing processes, reducing the number of components, and consequently minimizing the environmental impact.

Given these challenges, there is a clear need for innovative panels and associated structures that are designed specifically for wet environments, combining functionality with aesthetic appeal. There is also a requirement for a more efficient manufacturing process, which uses fewer components, thereby reducing costs and environmental impact. This invention aims to address these needs, offering a novel solution to the aforementioned problems prevalent in the related art.

### BRIEF SUMMARY

The unveiled technology introduces an innovative panel and related objects that are specially tailored for ink-imaged printing. These panels are characterized by their durability, resistance to both water and chemicals, and efficient construction using minimal components.

The panel is primarily made up of three core components:
A porous substrate plate, preferably constituted of acrylonitrile butadiene styrene (ABS), excluding any bonded acrylic (PMMA) to the ABS.
An ink image directly printed onto the substrate plate. This ink image can either be 3-dimensional, yielding a textured or non-planar front/outer surface, or 2-dimensional, resulting in a non-textured or planar front/outer surface.
A UV-cured coating applied directly over the printed image.

The uniqueness of these panels and their derivative accessories lies in their composition, solely using these three components—the substrate plate, the ink-printed image, and the UV-cured coating. This simple yet effective composition combined with their innovative manufacturing processes makes the components both novel and nonobvious.

The 3-dimensional ink-printed images, in certain embodiments, create a front/outer surface that provides a tactile texture and enhanced visual appeal. This textured design can imitate the appearance and feel of various natural and man-made items, such as textured stone, brick, wood, pebbles, foliage, as well as diverse patterns and scenic visuals like waterfalls or woodlands. These 3D panels, favorably utilized as “one panel per wall” or “one panel per image,” have a major advantage of eliminating grout lines, thereby acting as a superior alternative to conventional tiled bath and tub enclosures.

On the other hand, some alternative designs employ 2-dimensional ink images, creating a flat or planar front/outer surface. Despite being flat, the high-quality printing ensures they are still aesthetically pleasing, mirroring natural elements and various patterns. These 2D panels, although less preferred than their 3D counterparts, are particularly suited for thermoforming, allowing for the creation of curved or uniquely shaped walls or accessories. Similarly, these 2D panels, when used as “one panel per wall” or “one panel per image,” are ideal for enclosures, eliminating the need for multiple tiles and grout lines.

In both 3D and 2D embodiments, a singular panel can be utilized for each wall, such as in the case of a three-walled bathtub enclosure. Here, instead of grout, only a silicone sealant is used to join and seal the panels, offering an efficient, clean, and streamlined alternative to traditional multi-tiled and grout-filled enclosures.

In certain embodiments of the present disclosure, a bath or shower system has been disclosed. The bath or shower system incorporates a distinctively designed panel. At its core, this panel is characterized by a porous substrate plate onto which an image is directly printed using either 2-dimensional (2D) or 3-dimensional (3D) ink. The uniqueness of the 2D ink allows the plate and the printed image to be thermoformable, enabling them to be molded into non-flat, distinct shapes. In contrast, the 3D ink provides a tactile texture, replicating appearances such as stone, brick, wood, or similar materials. What's more, these textures are not only visually appealing but also protrude from the panel, adding a depth and tangible feel to the system. Following the printing, the image is protected and enhanced with a UV-cured coating, applied directly to it. This coating possesses several notable features: it's silicone-compatible (allowing for seamless sealing of multiple panels at their edges), it's non-porous, and it can secure panels together when supplemented with a silicone sealant.

Delving deeper into the panel's composition, the porous substrate plate is made of ABS (acrylonitrile butadiene styrene). Specific variations ensure that this ABS lacks any attached acrylic (PMMA). Further refining the panel's design, the ink, regardless of being 2D or 3D, adheres directly to this ABS plate. This is achieved without the intervention of binders, fusion promoters, or any intermediate layers. For additional purity in design, the ABS substrate plate intentionally avoids the incorporation of materials like aluminum and PVC (polyvinyl chloride).

On the production side, the system ensures that the formation of the porous substrate plate, the printing of the image, and the application of the UV-cured coating are undertaken in three distinct stages, each facilitated by a separate machine. Of these machines, the printing process, in particular, relies on the prowess of a digital UV-Printer. This printer, using the potency of ultraviolet (UV) light, cures the ink almost instantaneously as it interfaces with the porous substrate plate. Ensuring an even more refined product, there's an absence of any extrusion machine in either the printing or the coating application. The specific machinery employed includes a UV-Printer from SwissQPrint and a UV-cured coating machine from Tec Lighting.

The ink itself is not waterproof, necessitating the UV-cured coating, which is not only waterproof but also clear, ensuring the printed image remains prominent. This coating is further fortified, being resistant to a plethora of chemicals. Its surface remains pure and unaltered, devoid of varnishes, wood finishes, polyurethanes, lacquers, or shellacs. Additionally, it can be embedded with anti-microbial and anti-fungal properties, boosting its functionality.

The manufacturing process for the panels encompasses either a 3D texture design or a 2D image design. The 3D designs are tactile, reminiscent of materials like rock, stone, wood, or brick, achieved using specific inks such as the “KX2 ink” from SwissQPrint. Post printing, they are coated for waterproofing and resistance against chemicals. In the case of the 2D designs, vibrant visuals like waterfalls or forest vistas are printed and then coated. What's intriguing about these 2D designs is their capability to be thermoformed into intricate shapes, making them ideal for custom-made bath pans or shelves.

Lastly, during installation, a pioneering method is employed: silicone sealant is directly applied to the edges of the UV-cured coating, bridging multiple panels. This application technique, not previously recognized, ensures an unparalleled waterproof seal between panels.

The bath or shower system described offers numerous advantages that place it at the forefront of modern design and functionality. First and foremost, the use of a porous substrate plate made of ABS ensures a sturdy base, while the direct application of 2D or 3D ink provides both aesthetic appeal and functional diversity. The 3D ink grants a unique tactile experience by replicating real-world textures like stone and wood, enhancing the user's sensory interaction. The UV-cured coating is a game-changer: it not only protects the intricate designs from moisture (despite the inks not being waterproof), but its clear nature ensures that the vibrant designs shine through unhindered. This coating's compatibility with silicone introduces ease of installation and guarantees a watertight seal between panels, effectively eliminating potential leakage points. The thermoforming capability of the 2D designs offers unprecedented customization options, allowing for bespoke shapes that can cater to specific interior designs or spatial requirements. Moreover, the dedicated machinery involved, like the digital UV-Printer, ensures quick and efficient production, with the UV light instantly curing the ink, reducing wait times and potential errors. The exclusion of materials like aluminum and PVC emphasizes an eco-friendly approach. Lastly, the infusion of anti-microbial and anti-fungal properties into the coating further elevates the system's hygiene standards, making it an ideal choice for health-conscious consumers.

### BRIEF DESCRIPTION OF THE ACCOMPANYING DRAWINGS

The novel features which are believed to be characteristic of the present invention, as to its structure, organization, use, and method of operation, together with further objectives and advantages thereof, will be better understood from the following drawings in which a presently preferred embodiment of the invention will now be illustrated by way of example. It is expressly understood, however, that the drawings are for the purpose of illustration and description only and are not intended as a definition of the limits of the invention. Embodiments of this invention will now be described by way of example in association with the accompanying drawings in which:

FIG. 1 is a diagram that illustrate two large panels, in accordance with an embodiment of the present invention.

FIG. 2 is a diagram that illustrates an edge view of a panel, in accordance with an embodiment of the present invention.

FIG. 3 is a diagram that illustrate a 3D texture of a panel, in accordance with an embodiment of the present invention.

FIG. 4 is a diagram that illustrates a panel with 3D texture with glossy and matte coating, in accordance with an embodiment of the present invention.

FIGS. 5, 6, and 7 are diagrams that illustrate panels having a printed masonry/stone wall image, in accordance with an embodiment of the present invention.

FIGS. 8 and 9 are diagrams that illustrate a slate/stone wall image panel, in accordance with an embodiment of the present invention.

FIG. 10 is a diagram that illustrates a micro tub with wall panels, in accordance with an embodiment of the present invention.

FIGS. 11-17 are diagrams that illustrate panels with different patterns, in accordance with another embodiment of the present invention.

FIG. 18 is a diagram that illustrates a micro tub with wall panels, in accordance with another embodiment of the present invention.

Further areas of applicability of the present invention will become apparent from the detailed description provided hereinafter. It should be understood that the detailed description of exemplary embodiments is intended for illustration purposes only and is, therefore, not intended to necessarily limit the scope of the invention.

### DETAILED DESCRIPTION

As used in the specification and claims, the singular forms “a”, “an”, and “the” may also include plural references. For example, the term “an article” may include a plurality of articles. Those with ordinary skill in the art will appreciate that the elements in the Figures are illustrated for simplicity and clarity and are not necessarily drawn to scale. For example, the dimensions of some of the elements in the Figures may be exaggerated, relative to other elements, to improve the understanding of the present invention. There may be additional components described in the foregoing application that are not depicted on one of the described drawings. In the event such a component is described, but not depicted in a drawing, the absence of such a drawing should not be considered as an omission of such design from the specification.

Before describing the present invention in detail, it should be observed that the present invention utilizes a combination of components or set-ups, which introduces an innovative panel and related objects that are specially tailored for ink-imaged printing. These panels are characterized by their durability, resistance to both water and chemicals, and efficient construction using minimal components. Accordingly, the components have been represented, showing only specific details that are pertinent for an understanding of the present invention so as not to obscure the disclosure with details that will be readily apparent to those with ordinary skill in the art having the benefit of the description herein. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

References to “one embodiment”, “an embodiment”, “another embodiment”, “yet another embodiment”, “one example”, “an example”, “another example”, “yet another example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in an embodiment” does not necessarily refer to the same embodiment.

The words “comprising.” “having.” “containing.” and “including.” and other forms thereof, are intended to be equivalent in meaning and be open ended in that an item or items following any one of these words is not meant to be an exhaustive listing of such item or items or meant to be limited to only the listed item or items. Unless stated otherwise, terms such as “first” and “second” are used to arbitrarily distinguish between the elements. Thus, these terms are not necessarily intended to indicate temporal or other prioritization of such elements. While various exemplary embodiments of the disclosed invention have been described below it should be understood that they have been presented for purposes of example only, not limitations. It is not exhaustive and does not limit the invention to the precise form disclosed. Modifications and variations are possible considering the above teachings or may be acquired from practicing of the invention, without departing from the breadth or scope.

Keywords of the bath or shower system:
Porous substrate plate: In this context, it refers to the foundational component of the shower or bath system, designed to absorb or allow liquid or air to pass through.
ABS (Acrylonitrile Butadiene Styrene): A common thermoplastic polymer. Here, it's used as the material for the substrate plate, offering durability and sturdiness.
2D or 3D ink: Refers to the types of ink used for printing designs onto the substrate. 2D is flat, while 3D offers a raised, textured feel, enhancing the sensory experience.
UV-cured coating: A protective layer applied to the printed design, which is cured (or hardened) using ultraviolet light. In this system, it ensures that the designs are protected from moisture.
Silicone: A flexible, rubber-like material. In this context, it's used for sealing between panels to ensure they are watertight.
Thermoforming: A process where plastic is heated to a pliable state and shaped in a mold. The system's designs can be thermoformed, allowing customization of shapes to fit specific designs or spaces.
Digital UV-Printer: A type of printer that uses ultraviolet light to instantly dry or cure the ink it prints. This ensures fast, efficient production.
Anti-microbial and anti-fungal properties: Additives or features in a material (here, the UV-cured coating) that prevent the growth of microbes and fungi. It adds a hygienic dimension to the system.
Eco-friendly: Having a low impact on the environment. By excluding materials like aluminum and PVC, the system adopts a more sustainable, environmentally conscious approach.
Leakage points: Places where water might escape or leak. The silicone compatibility of the UV-cured coating ensures there are minimal leakage points between panels.
Panel: The main component of the bath or shower system, which carries the printed image and is protected by the UV-cured coating.
PMMA (Poly(methyl methacrylate)): A transparent thermoplastic. In this context, its absence from the ABS indicates a specific type of substrate composition.
Fusion promoter: A substance used to help materials bond together. Its absence suggests direct adhesion of the ink to the ABS substrate without any intermediary layer.
Chemical-resistant: Refers to the ability of the UV-cured coating to resist degradation or damage from chemicals. This increases the durability and longevity of the panels.
Texture: In the context of 3D ink, it denotes a raised design that can mimic surfaces such as stone, brick, or wood. It provides a tactile dimension to the printed design.
Thermoformable: The capacity of a material, in this case, both the 2D ink and UV-cured coating, to be reshaped using heat.
Extrusion machine: A device used to shape material by forcing it through a specialized tool. It's mentioned in relation to how some processes are not done using it.
Chill-roller or embossing roller: Tools that add texture to surfaces. The texture in this system is achieved without these tools, indicating the unique property of the 3D ink.
Digital flatbed UV-Printer: A specific kind of UV printer designed for flat surfaces, efficiently printing designs on the substrate plates.
Waterproof: A key property of the UV-cured coating, ensuring that the panel is protected against water damage.
Silicone-compatible: Describes the UV-cured coating's ability to adhere well with silicone, ensuring a secure and waterproof seal between panels.
Non-porous: The property of the UV-cured coating which ensures that it does not let water or air through, adding another layer of protection.

### Panel Composition and Methodology:

The presented innovation describes a panel composition comprising three distinct layers that streamline the panel creation process while ensuring optimal quality and functionality. The foundational layer of this composition is ABS (Acrylonitrile Butadiene Styrene), a thermoplastic polymer recognized for its robustness, resilience, and versatility. The significance of ABS in this composition is twofold: its intrinsic durability and its capability to serve as a direct substrate for the subsequent layer, the printed image.

In an embodiment, directly printed onto the ABS layer is an image, which can be either 2-dimensional or 3-dimensional in nature. The 3-dimensional image, in particular, offers a textured appearance and tactile feel, bringing about depth and a distinct aesthetic appeal to the panel. This directly printed image eliminates the need for intermediary layers or substrates, simplifying the production process.

In an embodiment, the third layer is a liquid coating, meticulously applied over the printed image. Once applied, this liquid layer undergoes a UV-curing process, which transforms it into a protective shield over the image. This UV-cured layer is integral to the panel's performance, offering scratch resistance, water-proofing, and chemical resistance.

In an embodiment, the panel, birthed from the described composition and method, can be adapted into two primary forms:
3-Dimensional Textured Panels and Accessories: This embodiment of the panel captures the depth and detail of the 3D image printed on the ABS. While this variant offers a textured appearance and feel, it retains all the durability traits including being non-brittle, scratch-resistant, water-proof, and resistant to chemicals. Furthermore, the 3D panel can undergo slight thermoforming, granting a bit of malleability to fashion accessories or panels with gentle curves or contours.
2-Dimensional Panels and Accessories: In contrast, the 2-dimensional iteration of the panel, though flat in appearance, offers greater flexibility in thermoforming. Since all three constituent layers/components (ABS, 2D image, and the UV-cured coating) of this version are thermoformable, it can be molded into a variety of intricate curvatures and shapes. This makes it particularly apt for creating curved or uniquely shaped walls and accessories, expanding design options for interiors.

In an embodiment, the advanced panel composition and methods put forth are specifically engineered to culminate in products that are not only functionally superior but also visually captivating. An embodiment of aesthetic refinement, these panels exude an unmatched visual allure that seamlessly complements diverse interior decor styles. This is not just about appearance; at its core, the panel is fortified with characteristics that make it highly resistant to water and chemicals. Such attributes render the panel and its accompanying accessories highly durable, ensuring a long lifespan even under continuous exposure to potential deteriorating agents.

Ease of installation stands as another pivotal advantage. Unlike some conventional panels which may require specialized tools, expertise, or lengthy procedures, these panels are designed for swift and hassle-free installation. Maintenance, too, is straightforward. Their inherent resistance to water and chemicals means they repel most common stains, making cleaning and upkeep straightforward.

The proposed porous substrate plate stands out as a beacon of innovation in the field of materials used for wet environments. Its distinctiveness is rooted in several key features that challenge and deviate from conventional wisdom and practices.
Adaptation to Wet Environments: The substrate plate, by design, is made porous, making it particularly well-suited for wet environments. This is a marked shift from the conventional thinking where materials for such applications are predominantly non-porous.
Uncoated Outer Surface: Adding to its novelty is the plate's outer surface which remains untainted by acrylic or any other polymer coatings prior to the printing process. Most industry-standard plates undergo a capping or coating process to seal off the porous nature, but this design boldly sidesteps that trend.
Unique Composition & Thermoformability: At the heart of this substrate plate lies acrylonitrile butadiene styrene (ABS), a robust polymer. The design ensures that the ABS remains unattached to acrylic (PMMA)—an uncommon practice in substrate plate construction. Beyond its composition, the plate's inherent thermoformability allows it to be molded into diverse shapes, a testament to its versatility.
Production Process: The methodology adopted for the creation of this substrate plate is also noteworthy. It is birthed from the extrusion of ABS pellets, which transform into a solid sheet or plate that boasts a pristine, planar front surface. Ideally, these pellets originate from recycled ABS, emphasizing a commitment to sustainable practices. Depending on its intended application, the thickness of the resultant sheet or plate is gauged between ⅛ inch to ½ inch.

In an embodiment, the novel porous substrate plate acts as an exemplary medium for receiving direct ink applications, allowing for vivid imagery that can either mimic the textures and patterns of real-world materials or offer entirely new aesthetic experiences.

The technology driving this innovative ink application is a large format, digital printer—specifically a UV-Printer. By employing ultra-violet light, the printer can dry and cure the ink almost instantaneously. A particularly favored machine for this process is the SWISSQPRINT Nyala 4 UV flatbed printer. Its precision and capabilities render it ideal for these high-quality, detailed applications. Types of inks and their applications include:
3-D Printing Inks: These specialized inks, when applied, produce an image with a three-dimensional outer surface. The result is a textured or non-planar finish that's tactile and visually engaging. A salient example would be replicating the intricate patterns and textures of naturally occurring materials, such as stone, brick, wood, pebbles, leaves, or trees. The outcome is lifelike, both in appearance and touch. A notable ink used for this purpose is KX2-ink™ by SWISSQPRINT™. This ink, while being flexible, does not lend itself significantly to thermoforming.
2-D Printing Inks: These inks, in contrast, yield a flat or planar image upon application. Despite its 2-dimensional nature, the precision and detail of the resultant image are uncompromised. From images of natural landscapes, like woodlands or canyons, to geometric patterns and designs, this ink captures them all with remarkable clarity. The T-Ink by SWISSQPRINT™ is particularly preferred for such applications due to its inherent thermoformability.

In an embodiment, the decision to use either 3-D or 2-D inks will hinge on several factors. The primary determinant would be the desired texture (or lack thereof) of the resultant image. Another key factor is the potential for thermoforming. The 2-D ink, given its thermoformable nature, presents more malleability in shaping and curving the printed material. In contrast, the 3-D ink, while offering tactile texture, does not lend itself as well to thermoforming.

In an embodiment, the foremost layer that comes into contact with external environments when panels and accessories are installed is the UV-cured coating. This outer layer, intrinsically non-porous, dictates the durability, resistance, and appearance of the panel or accessory. The UV-cured coating forms a seamless, direct layer over the printed image, without any intermediary materials such as binders, fusers, or other substances. This ensures an intimate contact between the inked image and the UV-cured coating, resulting in a consolidated finish. Notably, there's an absence of other external finishing materials like varnishes, polyurethanes, lacquers, shellacs, or any other form of waterproofing agents applied over this UV-cured layer. Such a direct and minimalist approach makes sure that the inked image beneath remains vibrant and unobstructed.

In some embodiments, while the substrate plate and the inks used for the imagery (both 3-D and 2-D) inherently lack waterproof qualities, the UV-cured coating stands as a vanguard against moisture. This renders the panel competent for use in wet environments. Further, the UV-cured layer is not just resistant to water but also offers a formidable defense against various chemicals. This includes typical cleaning agents, ensuring longevity and consistent appearance. Additionally, it has the resilience to withstand minor abrasions, further cementing its durability. Despite all its protective attributes, the UV-cured coating is transparent. This ensures that the meticulously crafted image beneath—whether it's 3-D textured or 2-D flat—is distinctly visible, allowing for the desired aesthetic appeal.

Upon installation, the panel is oriented such that the UV-cured coating faces outward, confronting the room's interior. This makes it the “front” or “exterior” surface. Thus, any exposure to moisture, cleaning agents, or other chemicals is borne solely by this UV-cured layer, protecting the intricate imagery beneath. In certain iterations, the UV-cured coating could be augmented with anti-microbial and/or anti-fungal additives. This feature is particularly beneficial for wet environments, curbing the growth of mold, mildew, and bacteria. It not only assures a hygienic surface but also ensures the panel/accessory retains its aesthetic appeal for an extended period.

In some embodiments, the UV-cured coating serves as a protective shield over the printed image, ensuring its longevity and resilience against environmental factors. A more profound dive into the ideal embodiment of this UV-cured coating and its application methods reveals its efficacy and utility. The selected UV-cured coating is presented onto the ink—whether 2-D or 3-D—in a liquid form. Subsequent to its application, it undergoes an immediate curing process facilitated by UltraViolet light. This ensures that the coating swiftly solidifies, adhering to the contours of the printed image beneath, especially pertinent for 3-D printed images that are inherently non-flat.

Among the myriad available, certain coatings have showcased superior compatibility and performance with the described technology. Particularly, the coatings by TEC Lighting, like TL-5006 UV Gloss and TL-5015K UV Matte, stand out. These coatings, especially the former, which is primarily composed of polyester or akin substances, have been found exceptionally conducive for the intended applications.

Attempting to position a pre-formed, flat layer over a 3-D ink image poses challenges, with potential issues like the creation of air pockets or spaces. Such anomalies could deteriorate the aesthetics, feel, and durability of the panel's front and the underlying image. Liquid application circumvents these challenges, offering a seamless, congruent layer over 3-D images.

A distinct advantage of the preferred UV-cured coating is its newfound compatibility with silicone. Traditional knowledge did not recognize silicone's capability to adhere and seal directly to UV-cured coatings. However, the innovative finding that silicone can indeed adhere to coatings like TL-5006 UV Gloss broadens its utility, enabling it to act as a sealant. Conventional silicone bath and tub sealants can be directly applied to the exterior surface of the UV-cured coating. This facilitates the sealing of adjacent panel edges, providing a robust and waterproof seal. Additionally, the same silicone sealant can be utilized for sealing accessory edges to adjacent panels.

Despite the non-traditional composition of the panel and accessories, the compatibility with conventional silicone sealants ensures that the installation remains straightforward and efficient. The ease of sealing the panels and accessories together amplifies the practicality of this innovative technology. Another salient feature of the TL-5006 UV Gloss UV-cured coating is its thermoformable nature. This means that if any thermoforming is required, the UV-cured coating can be applied directly to the ink beforehand, facilitating further processing.

### Unique and Non-Obvious Features of the Panel Embodiments

The innovative attributes of the panel embodiments significantly distinguish themselves based on a distinct focus on simplification and precision. Here, the uniqueness emerges not just from what's included in the panel but, more importantly, from what is purposefully excluded.
Composition of the Porous Substrate Plate: The substrate plate's primary material is ABS (acrylonitrile butadiene styrene). What makes this choice noteworthy is the omission of the conventionally added acrylic “capping” layer. Typically, this layer is introduced to ABS to render it resistant to water or moisture. However, in this embodiment, this acrylic layer is notably absent. The emphasis is on pure ABS devoid of any additions, making the panel free from any acrylic constituents.
Absence of Intermediary Materials: The panel does not incorporate any binder or fusion promotor materials positioned between the ABS substrate and either the 3-D or the 2-D inks. This omission ensures a direct interaction between the printed ink and the porous ABS substrate, fostering better adhesion and clarity.
Exclusion of Other Common Materials: Further differentiating itself from conventional panels, this embodiment purposefully excludes certain materials that might typically find their way into similar products. Specifically, the panel does not contain:
   1. Aluminum: Known for its strength and lightness.
   2. PVC (Polyvinyl Chloride): A widely used plastic material.
   3. PVC foam: Commonly used for insulation.
   4. Paper or Wood: Traditional materials for certain panel types.
Direct Printing vs. Lamination: One of the standout features is the method by which the image is applied to the panel. Instead of resorting to using films like acrylic or di-acetate that hold an image and are then laminated or adhered to the substrate, this embodiment emphasizes direct printing onto the porous substrate plate. This approach ensures clarity, durability, and authenticity of the image.
The Outermost Layer: The panel's outer layer, which is the most exposed to the environment, is the UV-cured coating. Contrary to other panels that might use varnishes, wood-finishes, or other protective layers, this embodiment prioritizes the UV-cured coating for its resilience and protective attributes. The only exception to this rule comes in the form of silicone, which is applied, in a limited manner, to the UV-cured coating. However, this application is restricted to the edges of the panel, specifically at the seams between panels, or interfaces between the accessories and the panels or other associated structures.

### Versatility of the 3-D and 2-D Printed Panels:

The proposed 3-D and 2-D printed panels are notably versatile, offering both aesthetic appeal and functional adaptability. They cater to a wide range of applications, from walls and floors to ceilings, making them an ideal choice for modern bathrooms, shower enclosures, and even bath spaces. Their design and material composition allow them to blend seamlessly into diverse architectural and interior setups.

3-D Printed Panels:
Planar Applications: Primarily, the 3-D printed panels are employed as flat or planar panels for walls, floors, or ceilings. Their lifelike textures add depth and character to the spaces they adorn.
Light Thermoforming: While the 3-D printed panels are majorly used in their planar form, their inherent flexibility, combined with the thermoformability of the ABS plate and UV-cured coating, permits them to undergo slight thermoforming. This capability facilitates their transformation into slightly curved structures. Examples include low-barrier accessories or shallow accessories with a smooth curvature.

### 2-D Printed Panels:

Planar Applications: Like their 3-D counterparts, the 2-D printed panels can also be used as flat or planar applications for walls, floors, or ceilings. They offer sharp, high-resolution imagery that brings vibrancy to any space.
Advanced Thermoforming: A distinguishing feature of the 2-D printed panels is their extensive thermoforming capability. The harmony between the thermoformable ABS plate, the UV-cured coating, and the 2-D ink allows these panels to undergo significant thermoforming. This property makes the 2-D printed panels an excellent choice for crafting more intricate, non-planar structures. For instance, they can be molded into shelves, curved shower floors, rims, or other complex accessories within a bath or shower enclosure.

Manufacturing Method for Panels/Accessories: Outlined here is the preferred methodology to produce the aforementioned panels and accessories:

ABS Plate Acquisition: The process begins by sourcing an ABS plate with a distinct front and back planar surface.

### Digital Printing:

The chosen image is directly printed onto the front surface of the ABS plate. This is achieved using a high-resolution digital printer, optimally a UV flatbed printer.
The UV component of the printer rapidly dries/sets the ink, forming the image.
Depending on the desired output:
   1. 3-D Printing: Intended to create a three-dimensional texture or effect on the image. This gives the image a tactile depth, which is distinctly protruding from the surface of the ABS plate. Notably, this is not achieved through extrusion, chill-roller, embossing roller, or lamination methods.
   2. 2-D Printing: Results in a flat image without any textured effects. This process is independent of any extrusion or lamination techniques.

### UV-Cured Coating Application:

Following printing, a liquid coating is applied directly over the image. This coating is then immediately cured using UV light.
The coating serves a dual purpose: protection and aesthetics. It's transparent or largely transparent, allowing the underlying image to be clearly visible.
Depending on the desired finish:
   1. A glossy finish can be achieved with certain formulations.
   2. Alternatively, a matte finish can be employed while still maintaining image visibility.

Optional Thermoforming: In specific instances, the panel, once printed and coated, can undergo a thermoforming process. This reshapes the panel, giving it a curved or non-planar form. Such thermoformed pieces can serve as unique panels or accessories complementing the standard panels.

Equipment and Processes: The entire manufacturing method employs three primary machines: an extrusion machine (for the ABS plate creation), a UV flatbed printer (for image printing), and a liquid-coating machine equipped with UV curing capability. Significantly, lamination is not a part of any step, emphasizing the direct application and curing processes.

Flexibility in Production: The outlined steps can either be carried out by a single manufacturer or multiple entities. The production can also be centralized in one facility or distributed across different locations, offering flexibility in operational strategies.

This manufacturing method efficiently integrates digital technology, material science, and production techniques to craft versatile and aesthetic panels and accessories. Through direct printing and UV curing processes, it avoids traditional lamination, ensuring superior product quality and durability.

The invention will now be described with reference to the accompanying drawings which should be regarded as merely illustrative without restricting the scope and ambit of the present invention.

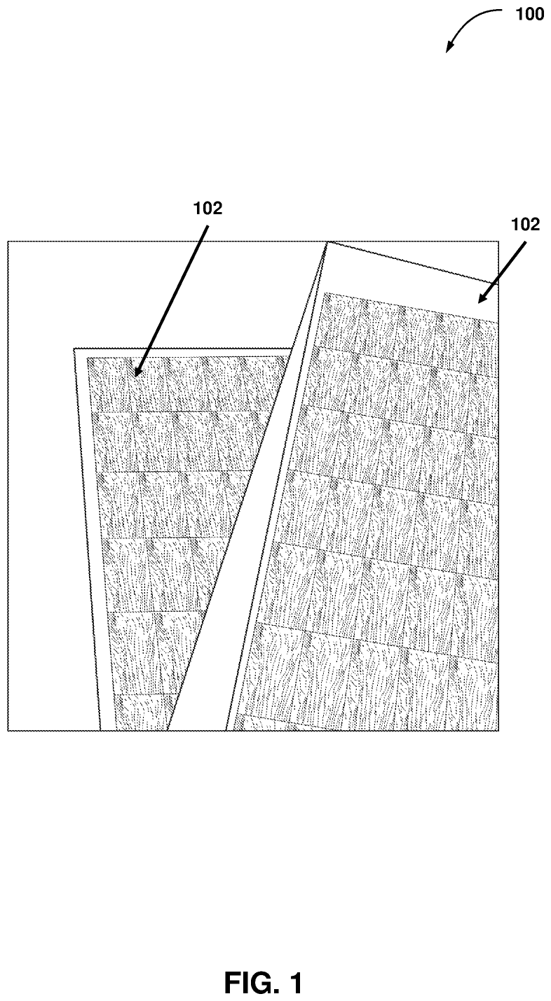

FIG. 1 is a diagram 100 that illustrate two large panels 102, in accordance with an embodiment of the present invention. These panels 102 are manufactured following specific methods as previously described. They are constructed using an ABS (Acrylonitrile Butadiene Styrene) substrate plate. Notably, this ABS plate does not have an additional acrylic cap or layer, which might typically be used to provide moisture resistance. The images or designs on these panels are printed using a machine named “SwissQPrint”. The design printed on these large panels 102 is a repetitive single pattern. Think of this like a wallpaper pattern, where the same design is repeatedly printed across the width and length of the ABS plate. Around the printed area of each panel 102, there's a visible white border. This border is the unprinted portion of the ABS substrate plate. It's akin to a margin or frame around the printed design. One of the standout features of the panel 102 is its adaptability. The panel 102 can be easily cut or resized to fit specific dimensions or areas where it needs to be installed. Even after cutting, the integrity and structure of the three layers (the ABS base, the printed image, and the protective UV-cured coating) remain intact. They do not crumble or disintegrate. This ensures that the panel retains its aesthetics and functionality even after modifications.

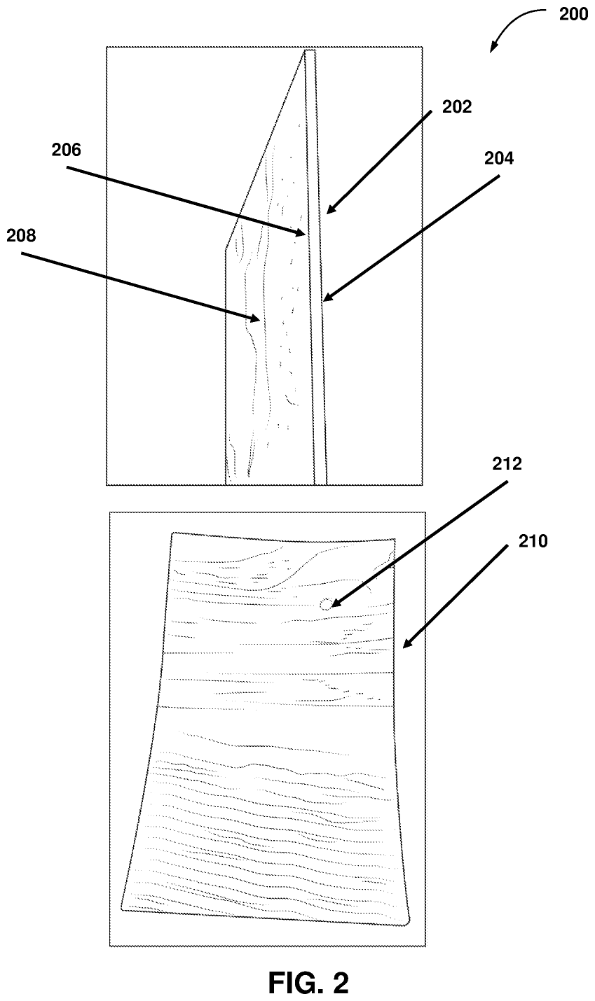

FIG. 2 is a diagram 200 that illustrates an edge view of a panel 202, in accordance with an embodiment of the present invention. In FIG. 2, the top photo provides a detailed side-view of a panel 202. This panel, constructed following certain specific methodologies, is comprised of three distinct layers. At its base lies the ABS substrate plate 204. Directly on this ABS substrate, a textured image is crafted using a special 3D ink, referred to as KX2 Ink and labeled as 206. Overlaying this 3D printed image is a glossy layer termed as the “enamel coating.” 208. It is important to note that this enamel coating 208 is applied directly over the 3D image, and there are no intermediary layers-no binders, primers, or any other materials. The phrase “enamel coating” in this context encompasses a broad definition, implying a coating that boasts properties of water resistance, durability, and flexibility. A preferable choice for such a coating is the UV-curable, resilient, and flexible polymer coatings produced by TEC Lighting. Among their range, the TL-5006 UV Gloss, which is primarily polyester-based, stands out, as does their matte-finish variant. These coatings have been consistently identified as being superior in quality for the majority, if not all, versions of the presented technology. In essence, the panel 202 becomes a prime example of a tri-layered composition perfectly suited for prolonged usage in moisture-prone areas, such as bathrooms.

Furthermore, the bottom photo in FIG. 2 introduces another variation, a panel 210. In this variant, a wood-pattern image 212, is printed directly onto the base layer using 3D ink. What sets this apart is the matte UV-cured coating that envelops the printed image 212, offering it protection and finish.

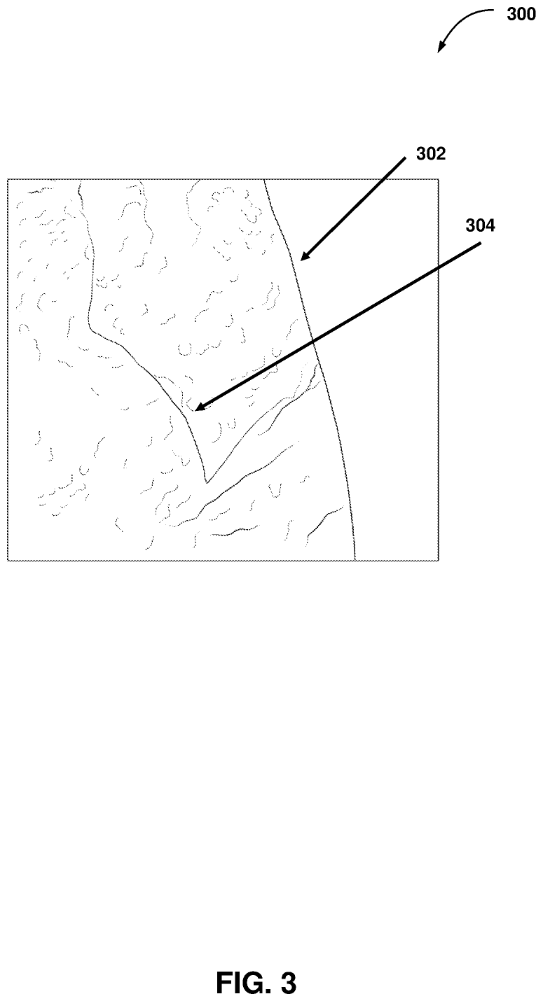

FIG. 3 is a diagram 300 that illustrate a 3D texture 304 of a panel 302, in accordance with an embodiment of the present invention. In FIG. 3, the top image showcases the panel 302, which has been constructed in line with specific design methodologies. At its core, this panel, ideally, is primarily made up of three key layers. Beginning with the foundational layer, there is the ABS substrate plate. On this base, an intricately textured image is directly etched using a specialized 3D ink, notably referred to as KX2. This vivid texture results in a pronounced three-dimensional appearance and tactile feel. Finalizing the composition of this panel 302, a glossy coating envelope the 3D image. Notably, this coating is laid out without the assistance of any intermediary layers—there are no binders, primers, or other materials introduced between the printed image and the glossy finish. An exemplary feature of this image is its 3D texture 304. This texture, particularly representing a slate pattern, is not merely visual but is also tangible, enhancing the overall aesthetic and tactile experience of the panel.

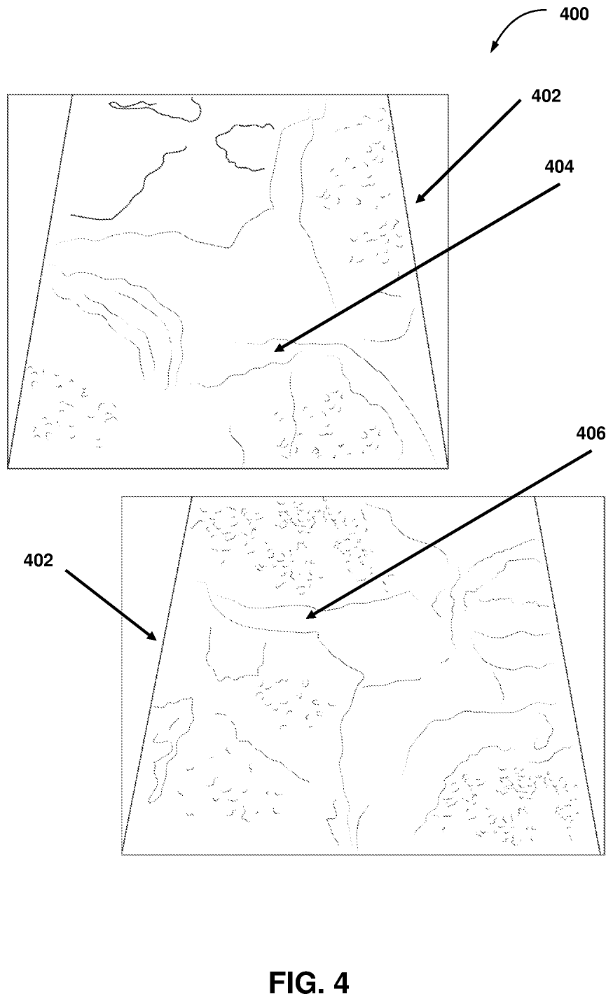

FIG. 4 is a diagram 400 that illustrates a panel with 3D texture with glossy and matte coating, in accordance with an embodiment of the present invention. In FIG. 4, the images depict panels 402, which are either similar or identical, crafted based on specific design principles. These panels 402 showcase two distinct finishes: a glossy coating 404, as seen in the top image, and a matte finish 406, as presented in the bottom image. These varied finishes are tailored to cater to different aesthetic preferences of customers. Despite their visual differences, both the glossy and matte coatings 404 and 406 share common characteristics. They are both water-resistant, long-lasting, pliable, and are cured using ultraviolet (UV) light.

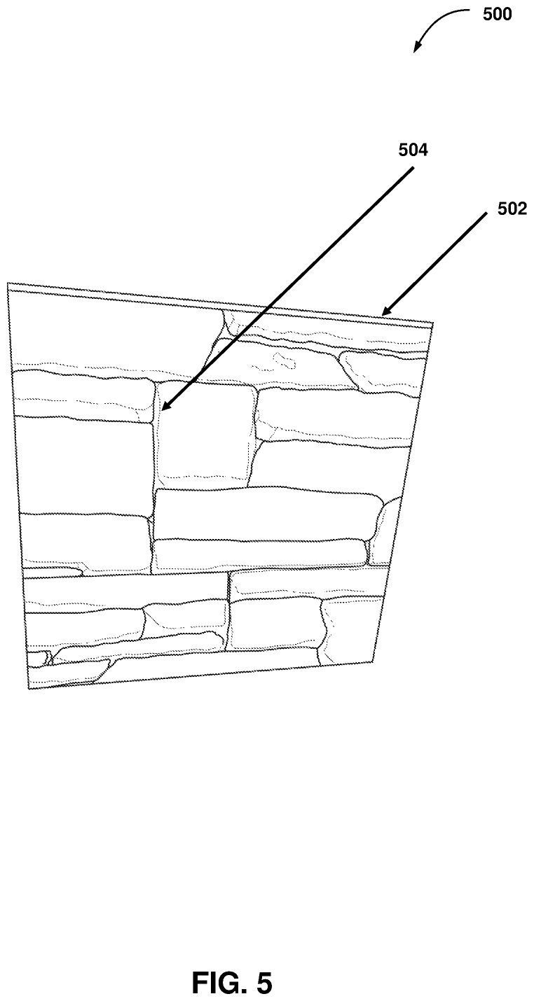

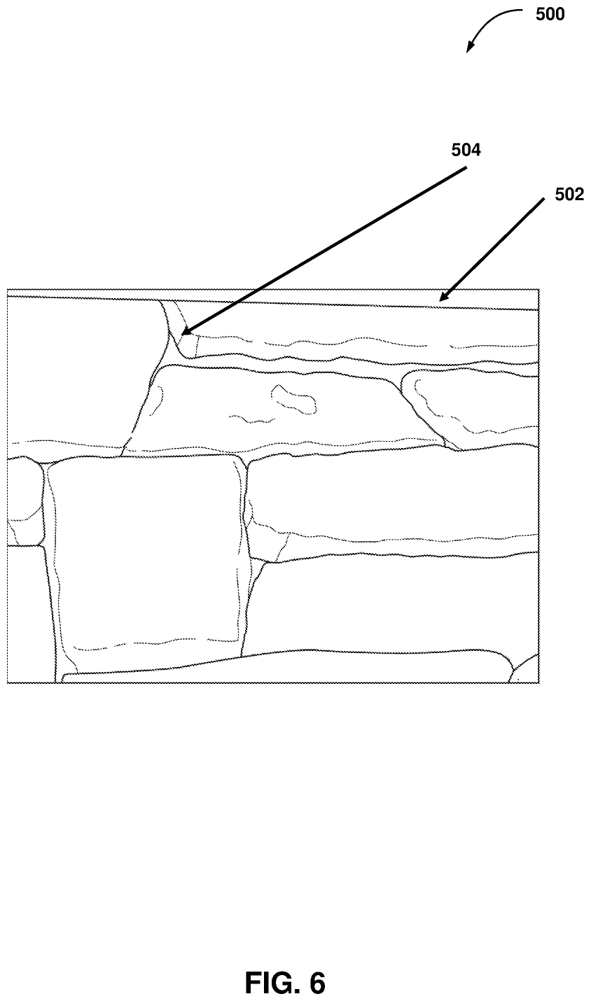

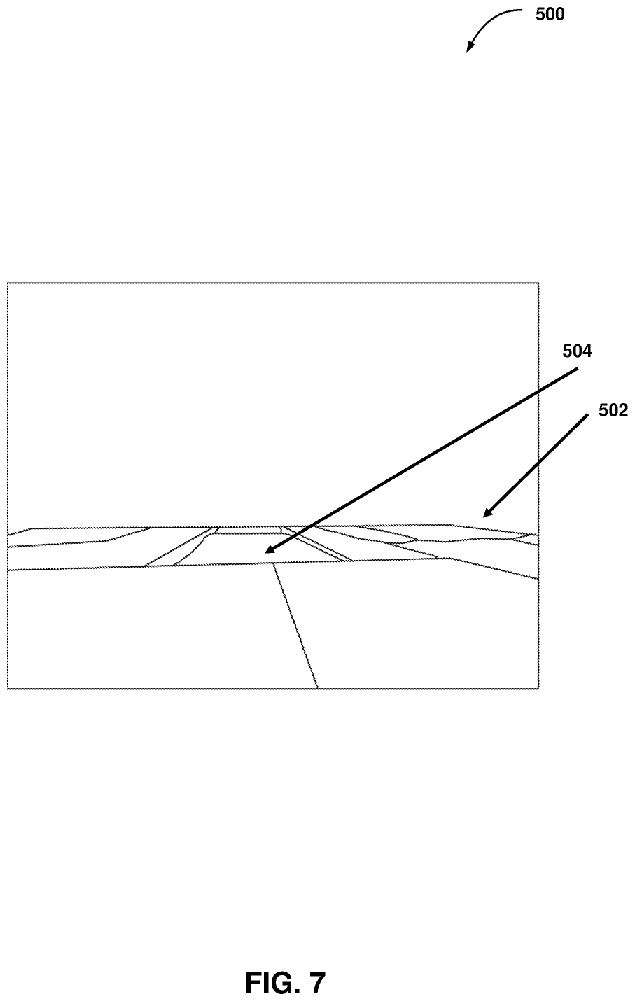

FIGS. 5, 6, and 7 are diagrams 500 that illustrate a panel 502 having a printed masonry/stone wall image 504, in accordance with an embodiment of the present invention. FIGS. 5, 6, and 7 showcase the panel 502, which has been crafted based on particular design principles and features a printed image of a masonry or stone wall, denoted as 504. FIG. 6 provides a more detailed view, as it is a close-up of a segment shown in FIG. 5. Meanwhile, FIG. 7 offers a perspective from the edge. A notable characteristic of this panel 502 is its pronounced texture, often referred to as “relief.” The panel 502 is distinguished by its large recesses and indentations, which are intentionally designed to give the wall a genuine look and tactile feel, simulating the authenticity of a real masonry or stone wall.

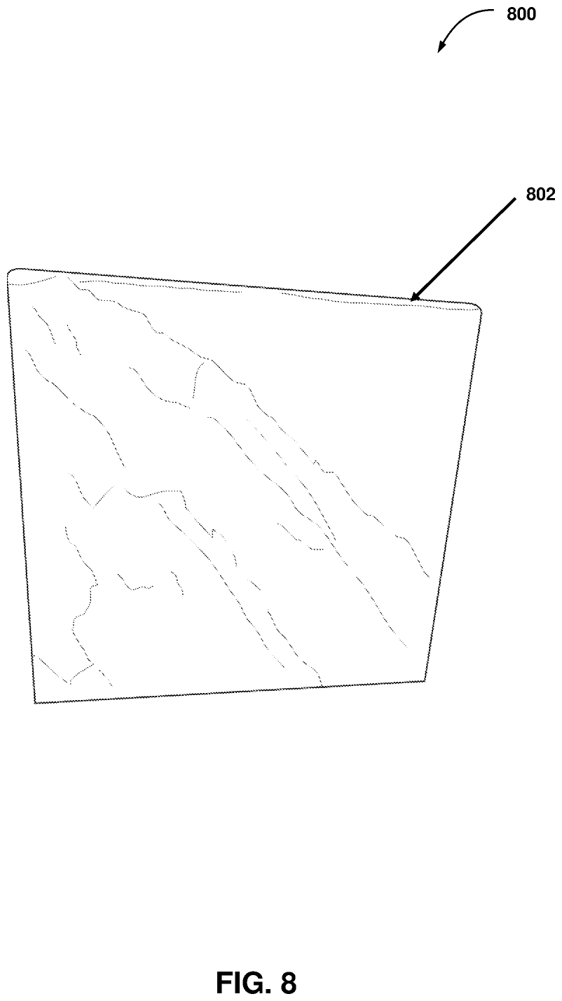

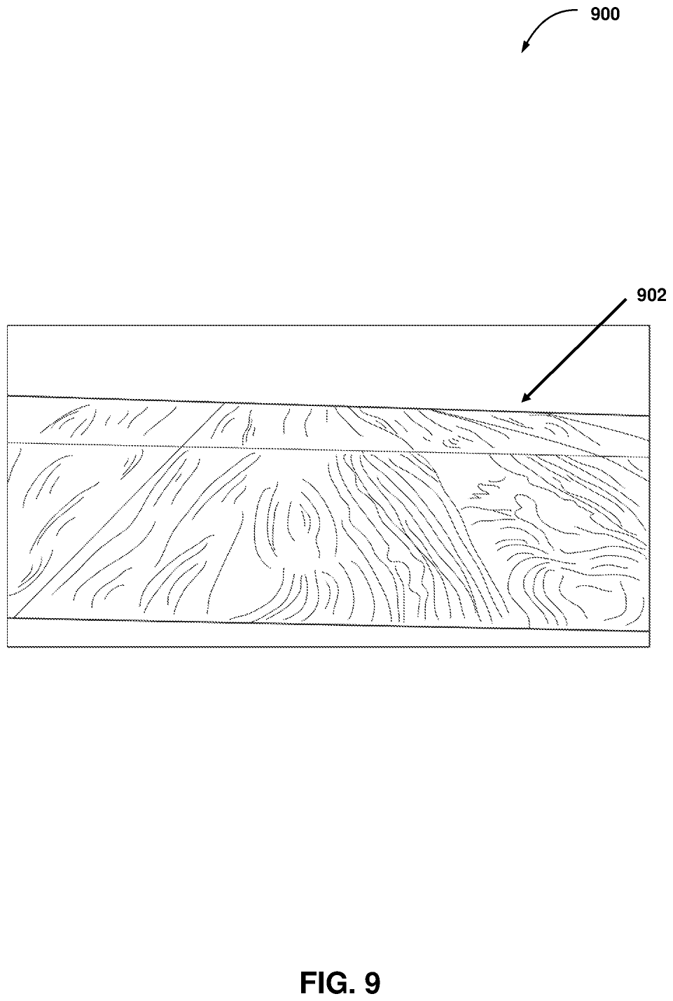

FIGS. 8 and 9 are diagrams 800 and 900 that illustrate a slate/stone wall image panel, in accordance with an embodiment of the present invention. FIG. 8 displays a panel 802. which carries an image resembling a slate or stone wall. In contrast, FIG. 9 presents another panel 902, which features an image resembling wood. These images underline the impressive diversity in color and texture that can be achieved, enabling the panels to mimic a range of natural materials. Although not explicitly depicted, it's important to understand, based on the provided document, that there is potential to design panels showcasing picturesque landscapes. Such images can range from cascading waterfalls and dense forests to open fields and beyond.

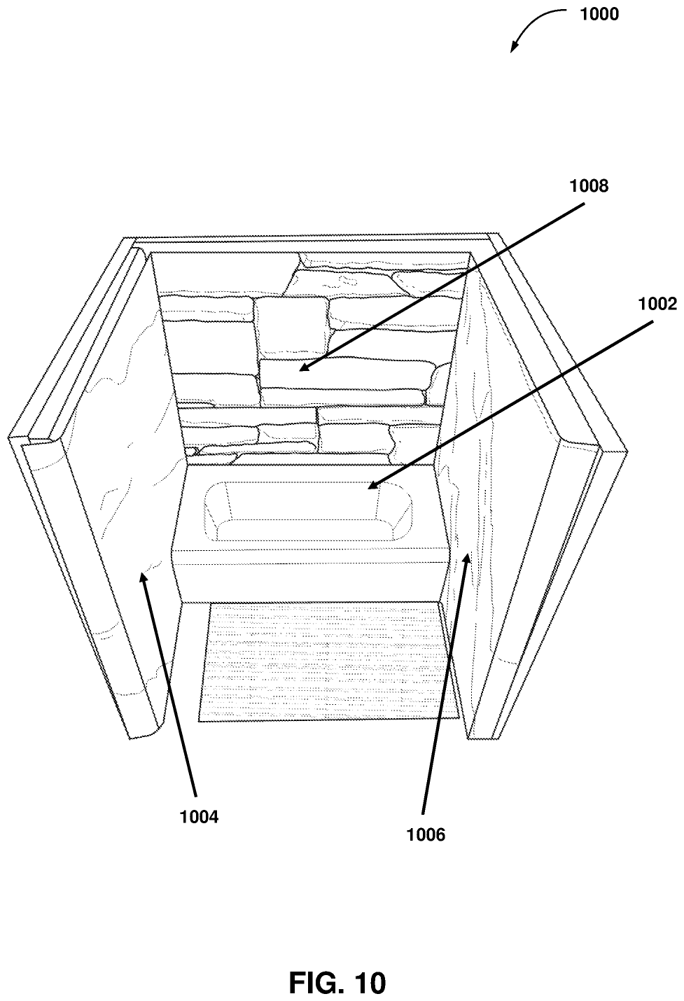

FIG. 10 is a diagram 1000 that illustrates a micro tub 1002 with wall panels 1004, 1006, and 1008, in accordance with an embodiment of the present invention. The design depicts the tub 1002 being encapsulated and securely sealed by these panels 1004, 1006, and 1008. A traditional applicator, combined with a widely available silicone sealant called Nexo-Flex™, is employed to fuse the panels 1004. 1006, and 1008 to one another and to the tub 1002. Any excess silicone from the sealing process is smoothed out and removed, resulting in a clean finish. Notably, while the sealing methods used align with conventional practices, there's a distinctive difference: the silicone is applied directly onto the panels 1004, 1006, and 1008, specifically onto their UV-cured coating, without the need for any primers, bonding layers, or other preparatory measures. This direct application ensures that the silicone can chemically bond to the panels 1004, 1006, and 1008 in a reasonable timeframe, like 24 hours, ensuring a robust and enduring seal between the panel edges and between the panels and the tub. The final seal, evident in both horizontal and vertical seams, is not only robust and long-lasting but also boasts a sleek and visually appealing finish.

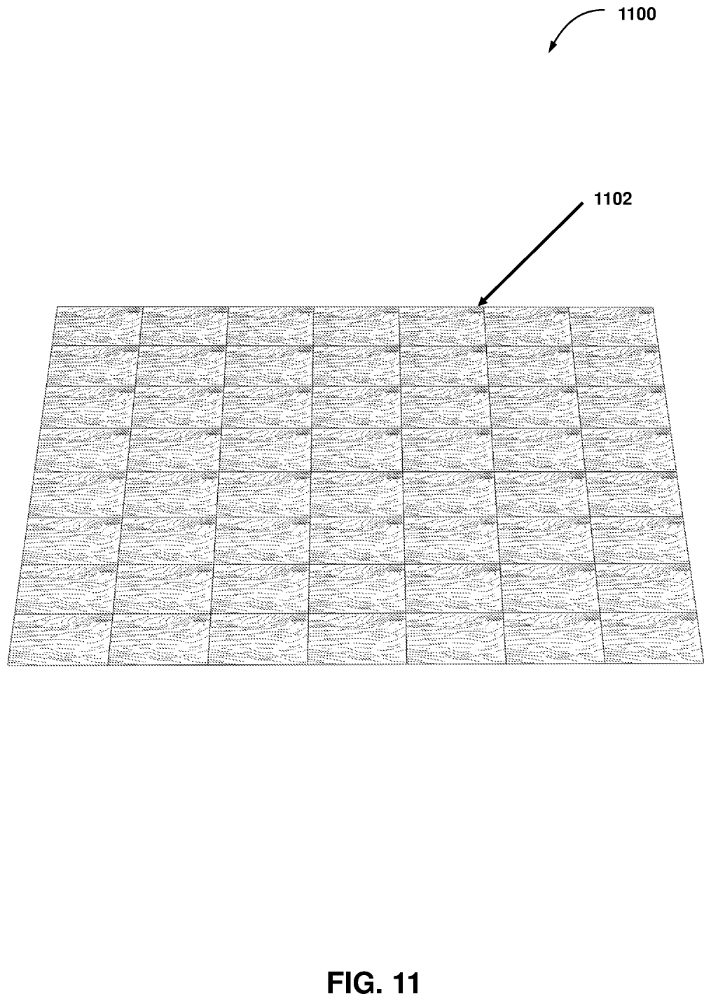

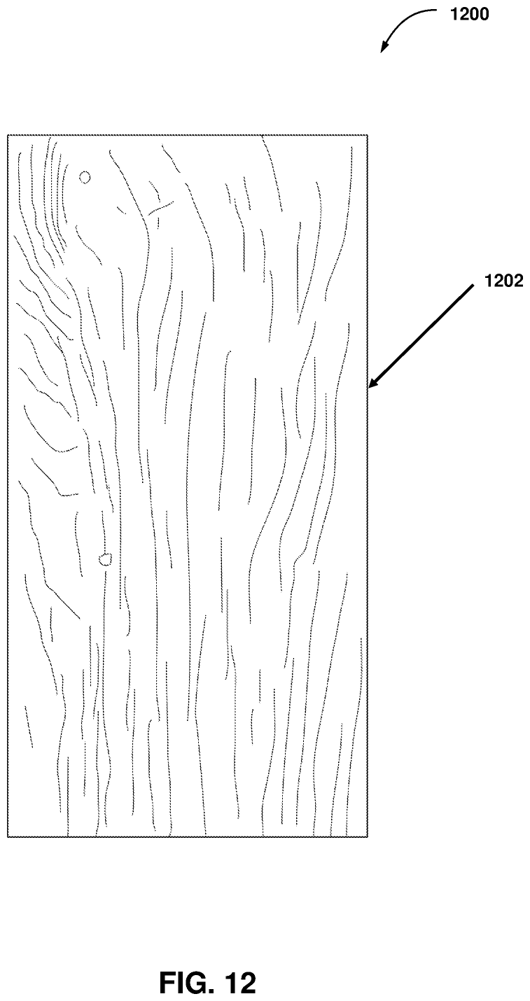

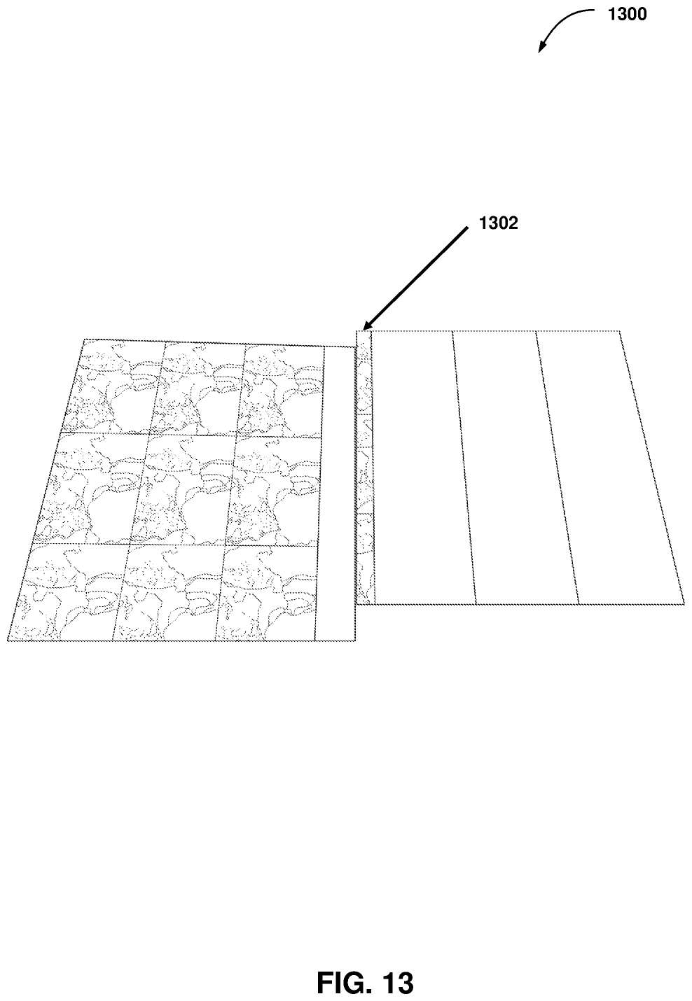

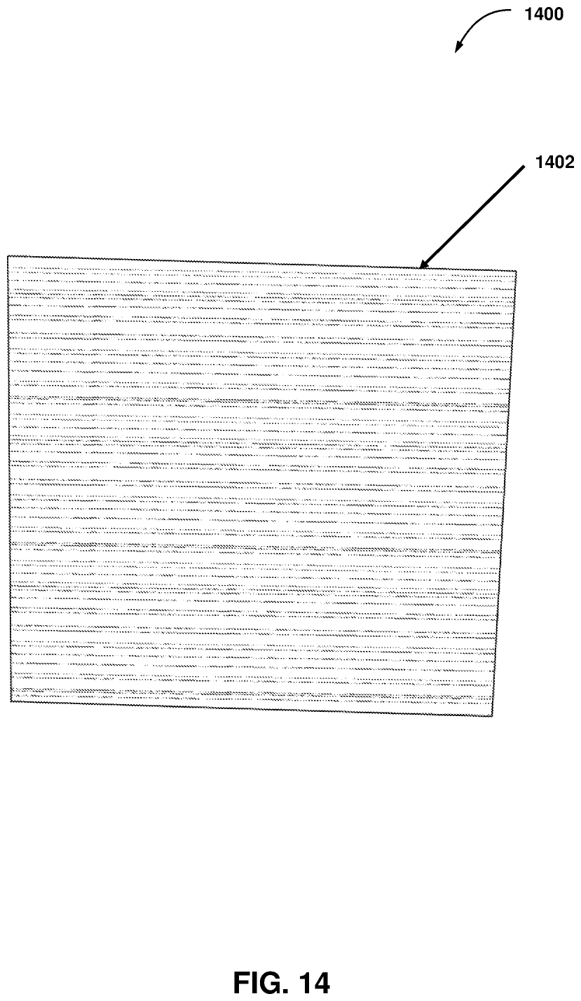

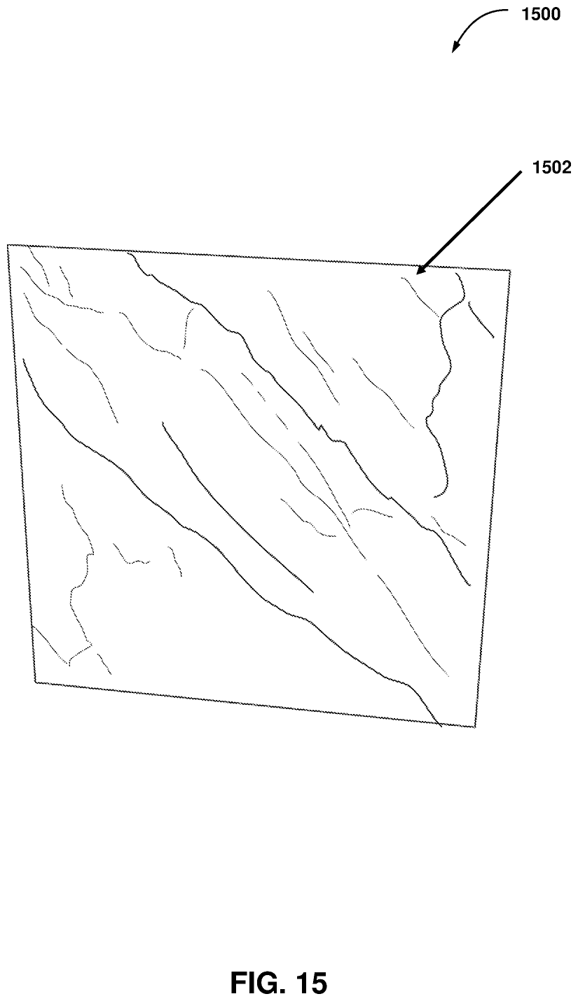

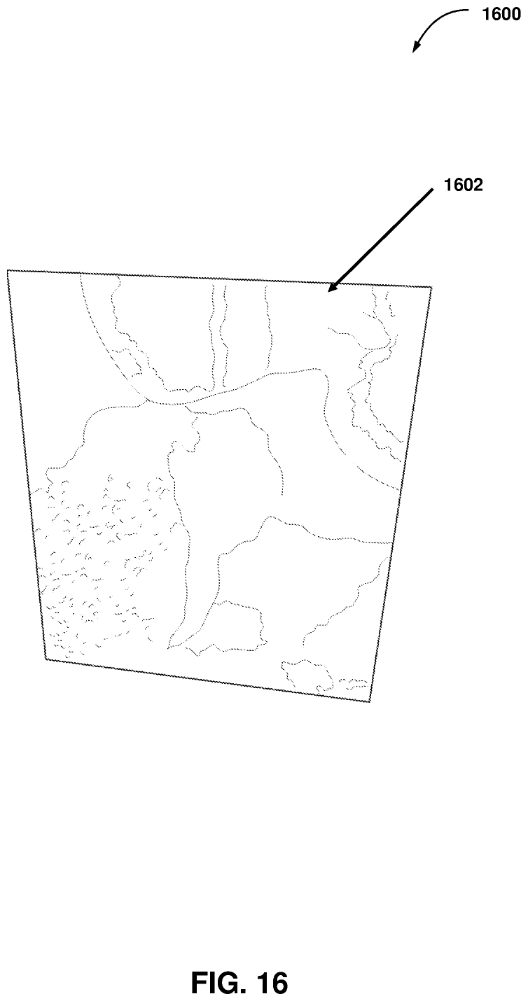

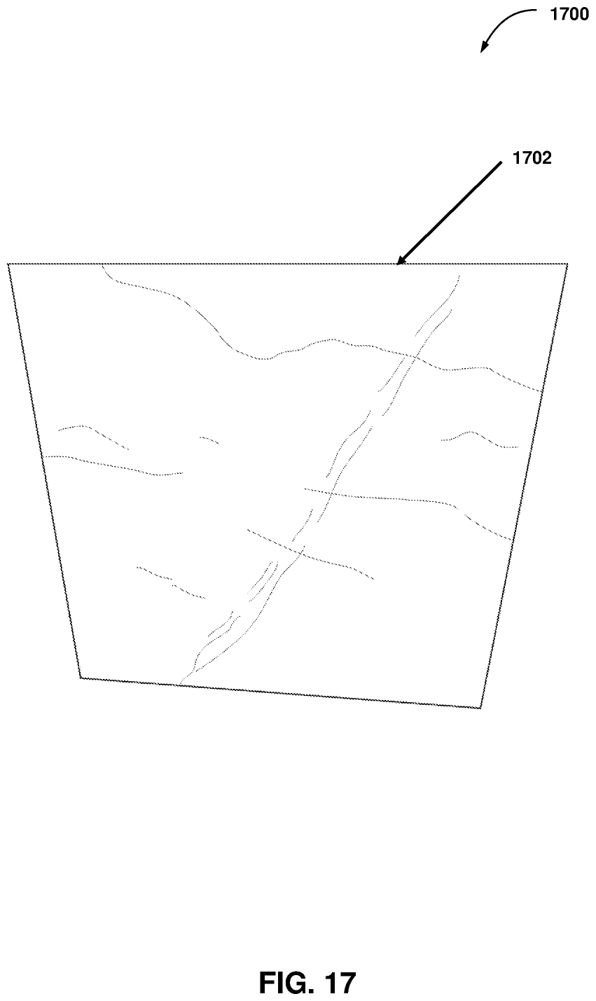

FIGS. 11-17 are diagrams 1100, 1200, 1300, 1400, 1500, 1600, and 1700 that illustrate panels with different patterns, in accordance with another embodiment of the present invention. FIG. 11 through FIG. 17 exhibit a diverse range of patterns, each emphasizing the depth and texture specific to the panels they adorn. FIG. 11 features a slate pattern on a panel 1102, demonstrating its unique texture and depth. Following that, FIG. 12 displays a wooden pattern on a panel 1202, providing a tactile and visual experience of its intricate grain and depth. In FIG. 13, a flag pattern is showcased on a panel 1302, revealing its texture and dimensions. FIG. 14 then presents a denim texture on a panel 1402, emphasizing the familiar weave and depth inherent to the fabric. Moving to FIG. 15, the panel 1502 portrays a stone pattern, capturing its natural intricacies and three-dimensional texture. Next, FIG. 16 highlights a flagstone pattern on a panel 1602, illustrating its distinct texture and depth. Lastly, FIG. 17 offers a view of a granite pattern on a panel 1702, emphasizing the depth and rich texture of this polished stone. Each of these panels, through their respective patterns, provides a visual and tactile representation of the materials they mimic.

Various panels have been intricately designed to emulate diverse materials, each reflecting a unique depth and texture that resonates with its real-world counterpart. The slate pattern, for instance, showcases the multi-layered, fissured characteristics typical of slate rock, giving a tactile sensation and a genuine visual appeal. The wood pattern brings forth the natural grain and warm depth of timber, offering both the look and feel of authentic wood. The flag pattern is not only visually stimulating but also rich in texture, giving the surface a multi-dimensional appearance. The denim pattern, drawing inspiration from the everyday fabric, replicates the woven intricacies and the recognizable texture of denim jeans. This brings a touch of familiarity and modernity to any setting. Venturing into the realm of masonry, the stone pattern encapsulates the rugged and uneven surface of raw stone, providing a robust and earthy ambiance. The flagstone pattern has an even more distinct texture, capturing the layered and slab-like appearance typical of pathways and patios. Lastly, the granite pattern is a tribute to the luxurious and polished nature of granite surfaces, highlighting its speckled design and glossy texture. Each panel's design not only mimics its respective material visually but also recreates its texture, providing a holistic experience that blurs the line between imitation and reality.

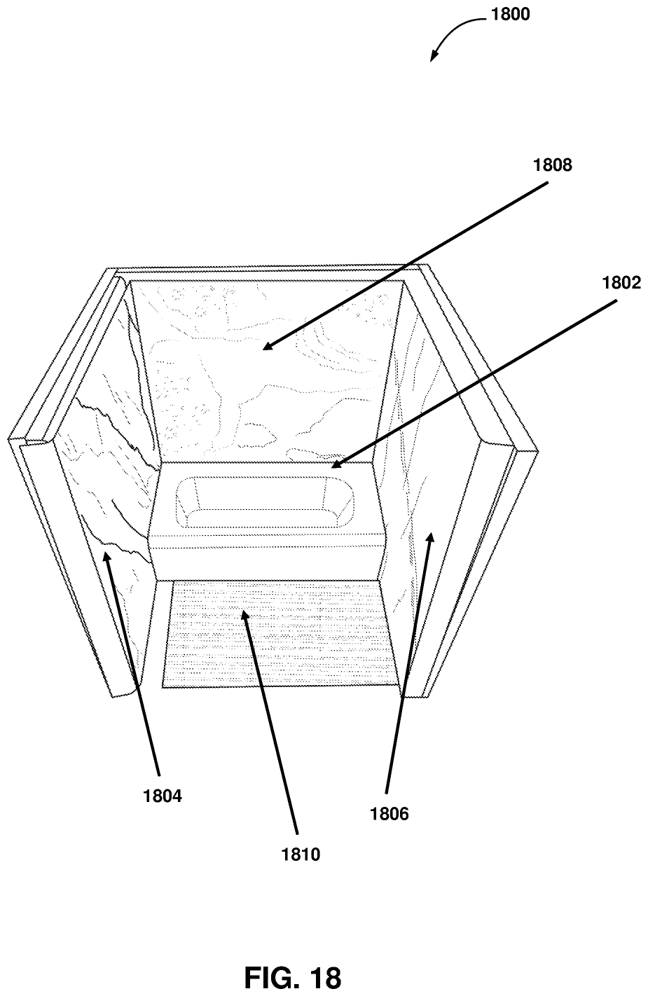

FIG. 18 is a diagram 1800 that illustrates a micro tub 1802 with wall panels 1804, 1806, and 1808, in accordance with another embodiment of the present invention. In FIG. 18, a detailed representation of a bathroom model is provided. This bathroom features a bathtub 1802, which is surrounded by three walls 1804, 1806, and 1808. These walls captivate attention with their slate and stone-like appearances. Remarkably, these are not natural stone walls; they are sophisticated panels crafted based on the innovative embodiments described in this technology. Not to be overshadowed, the floor also boasts a distinct feature: a blue panel, 1810, reminiscent of blue denim. Apart from its visual allure, this floor panel is functional and designed keeping the bather's safety and comfort in mind. It boasts a slip-resistant, subtly textured surface that ensures the bather's skin remains unharmed upon contact. The installation process for these panels is quite streamlined. They can be affixed against surfaces, such as plyboard, using traditional adhesives. Furthermore, sealing the gaps or intersections between the panels, and between the panels and the bathtub, is made efficient by employing conventional silicone sealants. While the method of scaling is typical, what's notable is the direct application of the silicone sealant onto the panels, specifically atop the UV-cured coating. This direct application negates the need for any primers, bonding agents, or preliminary preparations. The adhesive property of the silicone ensures a formidable and lasting bond with the panels. This bonding process results in seals, both vertically and horizontally, that are not just durable but are also seamlessly integrated to provide a polished and pleasing finish to the bathroom's aesthetics. Using a conventional silicone sealant with the panels that have a UV-coating top surface offers significant advantages. When applied directly to this UV-coated surface, the sealant exhibits strong adhesive properties. Once applied, it undergoes a curing process over several hours, establishing a robust and permanent bond. This kind of adherence is not just superficial; it ensures that the panels remain firmly attached to adjacent panels or fixtures, even with prolonged exposure to moisture. As a result, when these panels are used in environments that are frequently wet, like bathrooms or shower areas, the bond remains sturdy and reliable over many years, ensuring longevity and durability.

In various designs, without limiting the scope of the present invention, the panels may be crafted with intricate textures that provide functional benefits alongside their visual appeal. For instance, a panel can boast a “denim” texture which not only imitates the look and feel of denim fabric but also serves a critical safety purpose. This finely detailed texture ensures that the surface offers excellent grip, especially in environments prone to wetness, like bathrooms or showers. Such a surface greatly reduces the chances of slipping, making it a valuable feature for settings like homes with elderly residents or areas prone to moisture.

Highlighting the resilience of the printed image on the ABS substrate plate, imagine someone trying relentlessly to scrape or pick at the image. Their efforts would be in vain because the image is not merely placed on the ABS; it's bonded powerfully and permanently to it. This emphasizes the durability and robustness of the panel's design. The color and texture of this denim print are exceptionally vivid and realistic. Moreover, when you examine the ABS plate's construction in such designs, you'll note that the thickness of the plate is substantially greater than that of the printed image. Such designs can be presented in either matte or glossy finishes, depending on the desired aesthetic.

One notable feature in certain designs is the ability to bend the panel up to 90 degrees without any damage. Picture a panel so flexible that it can be smoothly bent around a corner, resulting in a seamless transition without any fractures, breaks, or chips. The key to achieving this perfect bend lies in the timing. Bending the panel within a week or two post-manufacture is optimal. Waiting longer might increase the risk of damages during the bending process. Such panels, regardless of their texture—whether light, moderate, or even substantially textured—retain this bendability within this specific timeframe.

Furthermore, a distinction exists between flexibility and bendability. Panels, as per this description, are inherently flexible, meaning they can withstand regular stress, such as temperature changes, installation pressures, or even someone leaning against them during a shower. Their flexible nature ensures longevity and resistance to regular wear and tear. However, if one desires to bend them sharply, say up to 90 degrees, it's best done within the first two weeks post-manufacture to prevent any potential damage. This combination of enduring flexibility and temporary bendability ensures panels that are not only visually appealing but also versatile and long-lasting.

In summary, the described invention is a bath or shower system panel. The panel is made up of a porous substrate plate, often made of ABS (acrylonitrile butadiene styrene). Directly onto this plate, an image is printed using either 2D or 3D ink. Over this image, a UV-cured protective coating is applied. Notably, this coating can bind with silicone, allowing for the joining of multiple panels. The coating is also non-porous. Some variations of this system incorporate a silicone sealant that aids in connecting the panel to others. While ABS is a common material for the substrate plate, some versions exclude PMMA from its composition. For certain iterations, the printing process is direct, eliminating the need for intermediate layers, fusion promotors, or binders. Furthermore, specific versions of the system ensure the plate is free from both aluminum and PVC materials. The described bath or shower system panel has a variety of features in its design. For one variant, a 3D ink is utilized to print images that mimic real-world textures such as stone, brick, or wood. These textures seem to jut out from the front of the substrate plate. Another version uses 2D ink for printing, with a unique feature that the substrate and the printed image can undergo a thermoforming process. Building upon this, there's an iteration where the UV-cured coating. in addition to the substrate and image, is also thermoformable, ensuring a unified transformation process. In a specific embodiment of this thermoformable system, the resultant shaped panel can serve various purposes: it might become a low-barrier base for showers, a curved wall, or even a functional accessory within the bathroom. The described bath or shower system boasts a panel that employs either 3D ink for realistic textures such as stone or wood or 2D ink for flat designs. Specifically, these systems use an ABS substrate. Regardless of the printing technique used, these panels are free of aluminum and PVC. While the ink used is not inherently waterproof, the system has a UV-cured coating that offers significant water resistance and maintains mostly transparency. This coating, moreover, is robust against chemicals. Uniquely, the panel's external surface is purely this UV-cured layer, ensuring it is not coated with any conventional finishes such as lacquer or varnish. To produce this system, the formation of the substrate, ink printing, and UV coating application are distinctly executed using separate machines. An extrusion tool forms the substrate, and the printing leverages a rapid-curing UV-Printer. Notably, when 3D ink is used, it introduces texture without relying on methods like chill-rolling or embossing. The specified bath or shower system employs an innovative production method. The application of the UV-cured coating is executed using a dedicated machine with UV-curing abilities. Remarkably, the production process avoids the use of extrusion techniques for both the image printing and the coating application. When it comes to the printing of the image, a UV printer is deployed, which possesses the capability to instantly cure the ink as soon as it touches the substrate plate. This swift and effective printing does not necessitate any intermediate layers or binders between the printed image and the substrate. Ensuring high product quality, the system is designed to exclude the usage of films, such as acrylic or di-acetate, between the substrate and the UV-cured coating. The printing component of this system specifically employs a UV-Printer sourced from SwissQPrint. In addition, while the UV printer and the machine applying the UV-cured coating are separate entities, the latter is obtained from Tec Lighting. Enhancing its functional value, the UV-cured coating in this system also incorporates anti-microbial or anti-fungal components, further ensuring a hygienic environment.

In one embodiment, the disclosed method elucidates the crafting process for a bath/shower system panel. It commences with the utilization of an ABS substrate that is notably absent of acrylic. Next, to create a distinctive texture on this substrate, 3D ink is applied. Particularly, the “KX2 ink” from SwissQPrint is the chosen ink for this purpose. Following this, a UV-cured coating is layered onto the textured substrate, bestowing it with both waterproof and chemical-resistant attributes. Further refinement of this process, as detailed in claim 33, ensures that before undergoing UV curing, this UV-cured coating, when in its liquid form, perfectly molds itself to the three-dimensional texture created earlier. Additionally, in an innovative twist to the process, the method can be adapted to incorporate the use of a silicone sealant, which is adeptly applied to seal the edges of the panels. Remarkably, this method facilitates the direct adherence of silicone to the UV-cured coating, a technique not previously recognized in the domain.

In another embodiment, the presented method elucidates the steps to fabricate a Bath/Shower System Panel or Thermoformed Accessories. It starts with the use of an ABS substrate which uniquely lacks any acrylic content. For the imaging phase, a direct 2D ink print is employed, specifically employing SwissQPrint's “T-ink” to craft the desired image. A UV-cured coating is subsequently layered on the printed substrate, ensuring its waterproofness and resistance to various chemicals. An advanced adaptation of the base method brings forth the possibility of thermoforming. This allows the panel to be molded into a myriad of shapes tailored for different applications, from bath pans to practical shelves. Further, when delving into the installation of these panels, there is an innovative approach introduced. Here, a silicone sealant is applied to the panel edges, serving as a scaling medium. This approach is notable as it unveils a pioneering technique where the sealant showcases direct adherence to the UV-cured coating, a fusion not conventionally observed.

The invention discussed pertains to specially designed panels with intricate textures and designs, primarily crafted for wet environments. Potential applications of these panels span across home and commercial interiors, especially in bathrooms and showers. They can be utilized as wall panels surrounding bathtubs, as flooring, and even on ceilings, offering cohesive design aesthetics. A standout feature is their varied textures, such as the “denim” texture, which, beyond its visual appeal, offers a safety advantage by preventing slips in wet conditions. Another remarkable feature is the resilient bonding of printed images on the ABS substrate plate, which ensures the image's longevity and resistance to wear and tear. This durability is further highlighted by the ability of these panels to be bent up to 90 degrees within a certain post-manufacture timeframe without suffering any damage. The use of conventional silicone sealants directly on these panels further simplifies installation and maintenance, reducing the need for additional binders or primers. In essence, these panels provide homeowners and businesses with a unique combination of aesthetics, functionality, and durability. They offer design flexibility with both matte and glossy finishes, the convenience of easy installation, and the assurance of long-lasting performance even in moisture-prone environments.

Although the present invention has been described with respect to various schematic representations (FIGS. 1-18), the proposed panels can be realized and implemented with varying shapes and sizes, and thus the present invention here should not be considered limited to the exemplary embodiments and processes described herein. The various dimensions may be modified to fit in specific application areas. Although particular embodiments of the invention have been described in detail for purposes of illustration, various modifications and enhancements may be made without departing from the spirit and scope of the invention.

What is claimed is:

1. A bath or shower system with a panel comprising:
a porous substrate plate;
a 2D or 3D ink printed image affixed directly onto said substrate plate; and
a UV-cured protective coating layered over the printed image.

2. The system of claim 1, wherein the UV-cured coating is receptive to silicone for the edge-sealing of multiple panels.

3. The system of claim 1, wherein the UV-cured coating exhibits non-porous properties.

4. The system of claim 1, incorporating a silicone sealant adhering to the UV-coated panel for connecting it with other panels.

5. The system of claim 1, wherein the substrate plate is composed of ABS.

6. The system of claim 5, where the ABS substrate is devoid of any PMMA composition.

7. The system of claim 5, wherein the ink is applied directly onto the ABS without an intermediary layer.

8. The system of claim 5, with the ink affixed onto the ABS without using fusion promotors or binders.

9. The system of claim 1, where the printed image uses 3D ink to simulate textures, such as stone, brick, or wood, protruding from the substrate's front plane.

10. The system of claim 1, featuring a 2D ink printed image, allowing the substrate and image to be thermoformed.

11. The system of claim 10, with the UV-cured coating being thermoformable, facilitating a cohesive thermoforming of the ABS substrate, printed image, and coating.

12. The system of claim 11, wherein the thermoformed panel could be a low-barrier shower base, a curved wall, or a bathroom accessory.

13. The system of claim 11, wherein UV-cured coating application involves a machine equipped with UV-curing capabilities.

14. The system of claim 11, where the UV-cured coating demonstrates resistance to chemicals.

15. The system of claim 11, wherein the panel's outermost surface is the UV-cured coating, untreated with finishes like wood varnish, polyurethane, or lacquer.

16. The system of claim 1, detailing that the substrate plate formation, image printing, and UV-cured coating application are distinct processes managed by separate machinery.

17. The system of either claim 1, in which the substrate is void of any aluminum content and is without any PVC components.

18. A method for creating a bath/shower system panel, comprising:
provision of an ABS substrate devoid of acrylic;
application of 3D ink for a distinctive texture, using KX2 ink;
a UV-cured coating for waterproofing and chemical resistance.

19. The method of claim 18, where the UV-cured coating, in its liquid state, conforms to the 3D texture prior to UV curing.

20. The method of claim 18, expanded to include the application of a silicone sealant for panel edge sealing, a novel method of adhering to the UV-cured coating.
